(19) United States
(12) Patent Application Publication
(10) Pub. No.: US 2018/0288684 A1
(43) Pub. Date: Oct. 4, 2018

(54) NETWORK SELECTION MECHANISMS FOR WIRELESS STATIONS THROUGH EMBEDDED HYPERTEXT MARKUP LANGUAGE PAGES

(71) Applicant: QUALCOMM Incorporated, San Diego, CA (US)

(72) Inventor: Ranga Rao Ravuri, Chennai (IN)

(21) Appl. No.: 15/473,286

(22) Filed: Mar. 29, 2017

(51) Int. Cl. H04W 48/16; H04W 8/00

(52) U.S. Cl. CPC H04W 48/16; H04W 8/005

(57) ABSTRACT

Methods, systems, and devices for wireless communication are described. A wireless station may transmit a probe request frame that is utilized in part by the wireless station to determine available wireless access points within a proximity of the wireless station. Then it may receive a probe response frame in response to the probe request frame, the probe response frame comprising a vendor information element (IE) type-length-value (TLV) that comprises a hypertext markup language (HTML) page with pictorial content. The station may then retrieve the pictorial content from the HTML page and render the pictorial content within an arrangement of the available wireless access points for selection.

### BACKGROUND

The following relates generally to wireless communication, and more specifically to network selection mechanisms through embedded hypertext markup language (HTML) pages.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a WLAN, such as a Wi-Fi (i.e., Institute of Electrical and Electronics Engineers (IEEE) 802.11) network may include AP that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via DL and UL. The DL (or forward link) may refer to the communication link from the AP to the station, and the UL (or reverse link) may refer to the communication link from the station to the AP.

There are many wireless devices in circulation today and users have become accustomed to widespread access to APs to connect to the Internet at various commercial, entertainment, and public venues such as offices, shopping malls, and coffee shops. Finding a proper AP, however, may be tedious because a user in a public area may be able to receive wireless signals from dozens of different APs at any given moment. In this scenario, a user usually activates the wireless capabilities on their device through various controls (e.g., soft-knob, settings, etc.), and scans for accessible wireless APs. A network manager on the device provides a list of APs as a list of alphanumerical strings, sometimes without network quality. The user may then to scroll through an oftentimes cumbersome list, select a preferred network, and then enter a password to access the network.

### SUMMARY

The described techniques relate to improved methods, systems, devices, or apparatuses that support enhanced network selection mechanisms through embedded HTML pages. Generally, the described techniques provide for a wireless AP to receive a probe request frame from a wireless station, and then transmitting a probe response frame which includes a vendor information element (IE) type-length-value (TLV) that comprises an HTML page with pictorial content in response to the probe request. Also, the described techniques provide for a wireless station to transmit a probe request frame and then receive a probe response frame which includes a vendor IE TLV that comprises a HTML page with pictorial content in response to the probe request. The wireless station may then retrieve the pictorial content from the HTML page and render the pictorial content within an arrangement of the available wireless APs for selection by a user of the station.

A method of wireless communication is described. The method may include receiving, at a wireless access point, a probe request frame that is utilized in part by a wireless station to determine available wireless access points within a proximity of the wireless station, identifying at least one compatible parameter with the wireless station based at least in part on the received probe request frame, and transmitting a probe response frame in response to the probe request frame, the probe response frame comprising a vendor information element (IE) type-length-value (TLV) that comprises a hypertext markup language (HTML) page with pictorial content.

An apparatus for wireless communication is described. The apparatus may include means for receiving, at a wireless access point, a probe request frame that is utilized in part by a wireless station to determine available wireless access points within a proximity of the wireless station, means for identifying at least one compatible parameter with the wireless station based at least in part on the received probe request frame, and means for transmitting a probe response frame in response to the probe request frame, the probe response frame comprising a vendor information element (IE) type-length-value (TLV) that comprises a hypertext markup language (HTML) page with pictorial content.

Another apparatus for wireless communication is described. The apparatus may include a processor, memory in electronic communication with the processor, and instructions stored in the memory. The instructions may be operable to cause the processor to receive, at a wireless access point, a probe request frame that is utilized in part by a wireless station to determine available wireless access points within a proximity of the wireless station, identify at least one compatible parameter with the wireless station based at least in part on the received probe request frame, and transmit a probe response frame in response to the probe request frame, the probe response frame comprising a vendor information element (IE) type-length-value (TLV) that comprises a hypertext markup language (HTML) page with pictorial content.

A non-transitory computer readable medium for wireless communication is described. The non-transitory computer-readable medium may include instructions operable to cause a processor to receive, at a wireless access point, a probe request frame that is utilized in part by a wireless station to determine available wireless access points within a proximity of the wireless station, identify at least one compatible parameter with the wireless station based at least in part on the received probe request frame, and transmit a probe response frame in response to the probe request frame, the probe response frame comprising a vendor information element (IE) type-length-value (TLV) that comprises a hypertext markup language (HTML) page with pictorial content.

In some examples of the method, apparatus, and non-transitory computer-readable medium described above, the pictorial content may be a brand icon or a picture of a face.

In some examples of the method, apparatus, and non-transitory computer-readable medium described above, the vendor IE TLV comprises an indication of a data size of the pictorial content.

In some examples of the method, apparatus, and non-transitory computer-readable medium described above, the pictorial content may be a graphics interchange format (GIF) image.

Some examples of the method, apparatus, and non-transitory computer-readable medium described above may further include processes, features, means, or instructions for associating with the wireless station over a network connection. Some examples of the method, apparatus, and non-transitory computer-readable medium described above may further include processes, features, means, or instructions for transmitting information associated with the pictorial content over the network connection.

In some examples of the method, apparatus, and non-transitory computer-readable medium described above, the transmitted information comprises a website of a vendor associated with the pictorial content, a sales offer from the vendor, and/or a message from an operator of the wireless access point.

In some examples of the method, apparatus, and non-transitory computer-readable medium described above, the at least one compatible parameter may be a supported data rate.

In some examples of the method, apparatus, and non-transitory computer-readable medium described above, the probe response frame may be transmitted at the supported data rate.

A method of wireless communication is described. The method may include transmitting, by a wireless station, a probe request frame that is utilized in part by the wireless station to determine available wireless access points within a proximity of the wireless station, receiving a probe response frame in response to the probe request frame, the probe response frame comprising a vendor information element (IE) type-length-value (TLV) that comprises a hypertext markup language (HTML) page with pictorial content, retrieving the pictorial content from the HTML page, and rendering the pictorial content within an arrangement of the available wireless access points for selection.

An apparatus for wireless communication is described. The apparatus may include means for transmitting, by a wireless station, a probe request frame that is utilized in part by the wireless station to determine available wireless access points within a proximity of the wireless station, means for receiving a probe response frame in response to the probe request frame, the probe response frame comprising a vendor information element (IE) type-length-value (TLV) that comprises a hypertext markup language (HTML) page with pictorial content, means for retrieving the pictorial content from the HTML page, and means for rendering the pictorial content within an arrangement of the available wireless access points for selection.

Another apparatus for wireless communication is described. The apparatus may include a processor, memory in electronic communication with the processor, and instructions stored in the memory. The instructions may be operable to cause the processor to transmit, by a wireless station, a probe request frame that is utilized in part by the wireless station to determine available wireless access points within a proximity of the wireless station, receive a probe response frame in response to the probe request frame, the probe response frame comprising a vendor information element (IE) type-length-value (TLV) that comprises a hypertext markup language (HTML) page with pictorial content, retrieve the pictorial content from the HTML page, and rendere the pictorial content within an arrangement of the available wireless access points for selection.

A non-transitory computer readable medium for wireless communication is described. The non-transitory computer-readable medium may include instructions operable to cause a processor to transmit, by a wireless station, a probe request frame that is utilized in part by the wireless station to determine available wireless access points within a proximity of the wireless station, receive a probe response frame in response to the probe request frame, the probe response frame comprising a vendor information element (IE) type-length-value (TLV) that comprises a hypertext markup language (HTML) page with pictorial content, retrieve the pictorial content from the HTML page, and rendere the pictorial content within an arrangement of the available wireless access points for selection.

In some examples of the method, apparatus, and non-transitory computer-readable medium described above, the pictorial content may be a brand icon or a picture of a face.

In some examples of the method, apparatus, and non-transitory computer-readable medium described above, the vendor IE TLV comprises an indication of a data size of the pictorial content.

In some examples of the method, apparatus, and non-transitory computer-readable medium described above, the pictorial content may be a graphics interchange format (GIF).

Some examples of the method, apparatus, and non-transitory computer-readable medium described above may further include processes, features, means, or instructions for receiving a selection of a wireless access point associated with the pictorial content. Some examples of the method, apparatus, and non-transitory computer-readable medium described above may further include processes, features, means, or instructions for associating with the selected wireless access point over a network connection. Some examples of the method, apparatus, and non-transitory computer-readable medium described above may further include processes, features, means, or instructions for receiving information associated with the pictorial content over the network connection.

In some examples of the method, apparatus, and non-transitory computer-readable medium described above, the received information comprises a website of a vendor associated with the pictorial content, a sales offer from the vendor, and/or a message from an operator of the selected wireless access point.

### BRIEF DESCRIPTION OF THE DRAWINGS

FIG. 1 illustrates an example of a system for wireless communication that supports enhanced network selection mechanisms through embedded HTML pages in accordance with aspects of the present disclosure.

FIG. 2 illustrates an example flow diagram that supports enhanced network selection mechanisms through embedded HTML pages in accordance with aspects of the present disclosure.

FIG. 3 illustrates an example of a probe response diagram in accordance with aspects of the present disclosure.

FIG. 4 illustrates an example of a graphical depiction by a wireless station of a rendering of pictorial content within an arrangement of the available wireless access points for selection in accordance with aspects of the present disclosure.

FIGS. 5 and 6 show block diagrams of a device that supports enhanced network selection mechanisms through embedded HTML pages in accordance with aspects of the present disclosure.

FIG. 7 illustrates a block diagram of a system including a AP that supports enhanced network selection mechanisms through embedded HTML pages in accordance with aspects of the present disclosure.

FIGS. 8 and 9 show block diagrams of a device that supports enhanced network selection mechanisms through embedded HTML pages in accordance with aspects of the present disclosure.

FIG. 10 illustrates a block diagram of a system including a STA that supports enhanced network selection mechanisms through embedded HTML pages in accordance with aspects of the present disclosure.

FIGS. 11 and 12 illustrate methods for enhanced network selection mechanisms through embedded HTML pages in accordance with aspects of the present disclosure.

### DETAILED DESCRIPTION

Before joining any network, a wireless station identifies available wireless access points. The identification process of the access points may be referred to as scanning. Many wireless stations can continually scan for a variety of access points. There are two scanning methods: passive scanning and active scanning. During passive scans, the station may listen for beacons. With a passive scan, the stations listens on each channel for beacons sent periodically by an access point. During active scans, the station sends probe requests to solicit probe responses from other devices. Scanning can be performed on a variety of different sets of channel ranges or frequencies. The probe response received by an active scan normally contains a media access control (MAC) address and the service set identifier (SSID) of the responding wireless access point.

A wireless device may be in active scan mode while transmitting probe request frames. An access point within range may respond with a probe response frame (containing capability information, supported data rates, etc.). The response frame may include different information elements (IEs) that are specified in the 802.11 specification. This includes both standard and vendor specific Type-length-value (TLV) based IEs. Specifications do not restrict what vendor content may be added. Due to this, vendors may put various data types in the vendor specific TLVs including HTML address tags associated with various image formats.

Because the vendor specific TLV can be used to represent an HTML page, the content can be of any image format or it can be of many other types. Any render-able content may be embedded in the frame. This may enhance the user experience by associating an icon/graphic to an access point appearing on a list of available access points. Humans in general are able to recognize icons and faces more easily than lists of alphanumeric strings. The icon/graphic may be a photo of the owner of the access point, or it could be a brand icon of the provider of the business providing the access point. On the wireless station side, the station's network selection tool may parse the HTML pages and render the picture/content as specified in the content types. This may provide simple and enhanced network selection options for the user.

Aspects of the disclosure are initially described in the context of a wireless communications system. Specific examples are described for receiving, at a wireless access point, a probe request frame that is utilized in part by a wireless station to determine available wireless access points within a proximity of the wireless station, identifying at least one compatible parameter with the wireless station based at least in part on the received probe request frame, and transmitting a probe response frame in response to the probe request frame, the probe response frame comprising a vendor IE TLV that comprises a HTML page with pictorial content. Also, examples are described for transmitting, by a wireless station, a probe request frame that is utilized in part by the wireless station to determine available wireless access points within a proximity of the wireless station, receiving a probe response frame in response to the probe request frame, the probe response frame comprising a vendor IE TLV that comprises a HTML page with pictorial content, retrieving the pictorial content from the HTML page, and rendering the pictorial content within an arrangement of the available wireless access points for selection. Aspects of the disclosure are further illustrated by and described with reference to apparatus diagrams, system diagrams, and flowcharts that relate to enhanced network selection mechanisms through embedded HTML pages

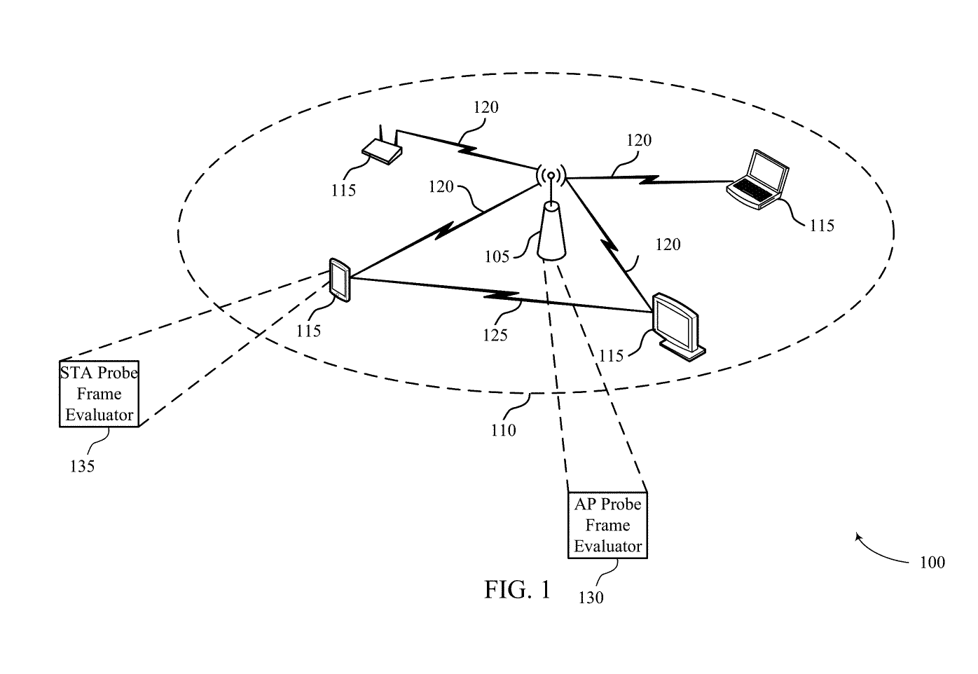

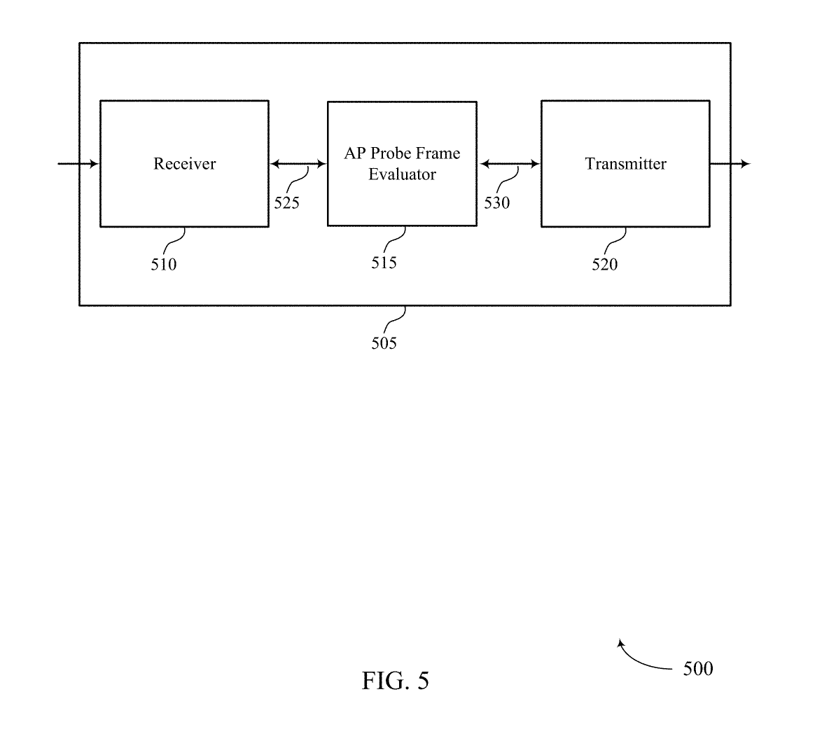

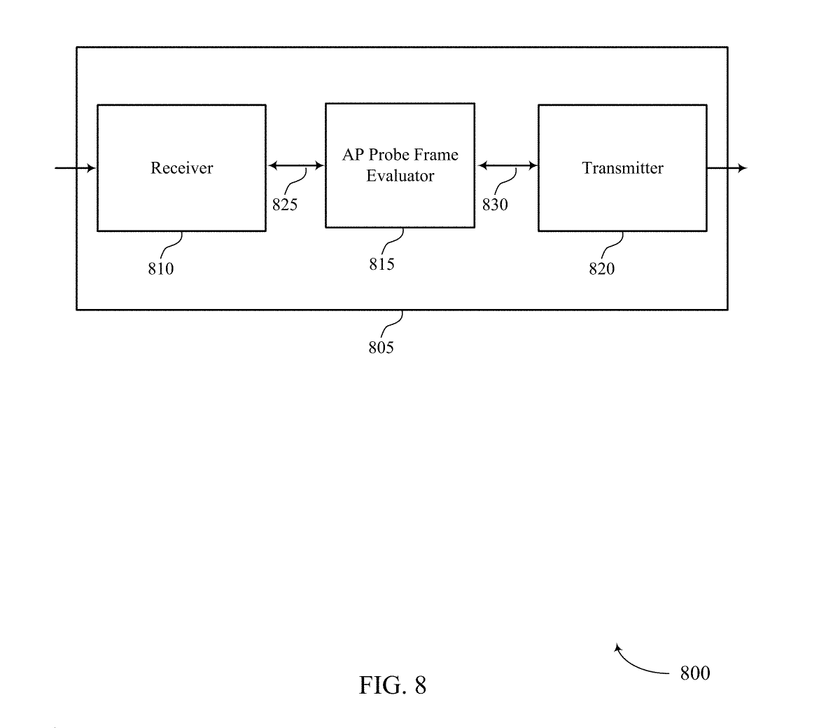

FIG. 1 illustrates a wireless local area network (WLAN) 100 (also known as a Wi-Fi network) configured in accordance with various aspects of the present disclosure. The WLAN 100 may include an access point (AP) 105 and multiple associated stations (STAs) 115, which may represent devices such as mobile stations, personal digital assistant (PDAs), other handheld devices, netbooks, notebook computers, tablet computers, laptops, display devices (e.g., TVs, computer monitors, etc.), printers, etc. AP 105 may include AP probe frame evaluator 130, which may be described, for example, in the descriptions for FIGS. 5-7. STAs 115 may include STA probe frame evaluator 135, which may be described, for example, in the descriptions for FIGS. 8-10. The AP 105 and the associated stations 115 may represent a BSS or an ESS. The various STAs 115 in the network are able to communicate with one another through the AP 105. Also shown is a coverage area 110 of the AP 105, which may represent a BSS of the WLAN 100. An extended network station (not shown) associated with the WLAN 100 may be connected to a wired or wireless distribution system that may allow multiple APs 105 to be connected in an ESS. In order to facilitate wireless connections, a wireless station may transmit a probe request frame to determine available wireless APs. Then the station may receive a probe response frame from an available AP containing a vendor IE TLV that comprises a HTML page with pictorial content. The station may then retrieve the pictorial content from the HTML page and render the content within an arrangement of the available APs for selection by a user.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN network 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN network 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an RTS packet transmitted by a sending STA 115 (or AP 105) and a CTS packet transmitted by the receiving STA 115 (or AP 105). This may alert other devices within range of the sender and receiver not to transmit for the duration of the primary transmission. Thus, RTS/CTS may help mitigate a hidden node problem.

An AP 105 may periodically transmit a frame known as a beacon frame. A beacon frame may contain information related to the WLAN. For example, a beacon frame may contain a timestamp for synchronization, an interval indicating the periodicity of the beacon frame (and thus the target beacon transmission time (TBTT)), information related to the capabilities of the network, a service set identifier (SSID), supported rates, frequency hopping parameters, direct-sequence parameters, contention-free access parameters, independent BSS (IBSS) parameters, and/or a traffic indication map (TIM). A TIM may indicate to a STA 115 whether an AP 105 has buffered frames waiting for the STA 115. In some cases, a beacon frame may also contain a delivery traffic indication message (DTIM), which may inform STA 115 about pending broadcast or multicast transmissions. After a TIM or a DTIM, an AP 105 may transmit the indicated data using carrier sense multiple access with collision avoidance (CSMA/CA). In some cases, STA 115 may enter a sleep mode between beacon frame transmissions to conserve power.

An AP 105 may transmit information relating to network connection or network condition to STA 115. A STA 115 may use this information when selecting a wireless host 105 with which to establish a connection. The STA 115 may additionally use a determined signal strength (e.g., a received signal strength, which may be represented by a received signal strength indicator (RSSI)) for each of a number of APs 105 when determining whether to select a wireless host 105 and communicate with the AP 105. The STA 115 may also request information from an AP 105. By using received network information, in addition to received signal strengths, when selecting an AP 105 for wireless communication, a STA 115 may establish a connection with an AP 105 which meets the STA's 115 preferences or service requirements.

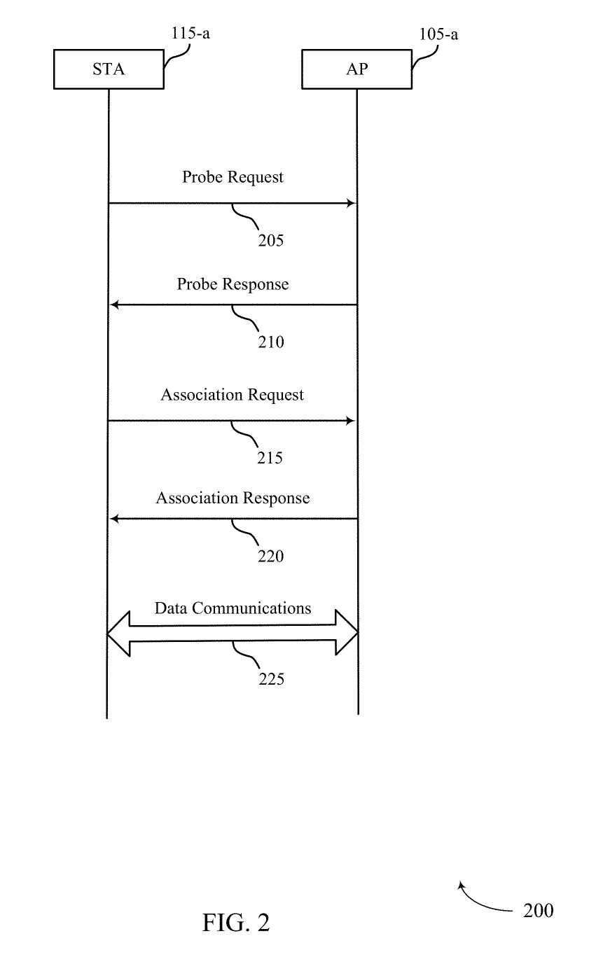

FIG. 2 illustrates an example of a flow diagram 200 for enhanced network selection mechanisms through embedded HTML pages. In some cases, flow diagram 200 may represent aspects of techniques performed by STA 115 or AP 105 as described with reference to FIG. 1.

Flow diagram 200 begins with STA 115-a as not being authenticated and associated with AP 105-a. At step 205, STA 115-a sends one or more probe requests to discover APs within its proximity. The probe request may advertise the STA's data rates and 802.11 capabilities. At step 210, APs receiving the probe request may check to verify that STA 115-a have a common supported data rate. In some embodiments, if AP 105-a and STA 115-a have compatible data rates, a probe response is sent advertising parameters such as the AP SSID (wireless network name), supported data rates, encryption types, and other 802.11 capabilities of the AP. AP 105-a may also include in the probe response a vendor IE TLV that includes a HTML page with pictorial content. The pictorial content may be a brand icon or a picture of a face. The pictorial content may also be a graphics interchange format (GIF) image. The vendor IE TLV may also comprise an indication of a data size of the pictorial content.

Upon receiving a selection of a wireless access point associated with the pictorial content, STA 115-a may transmit an association response to AP 105-a at step 215. The association may contain chosen encryption types and other compatible 802.11 capabilities. If the elements in the association request matches the capabilities of AP 105-a, it will create an association ID for STA 115-a and respond with an association response with a success message granting network access to STA 115-a at step 220. At step 225, STA 115-a is successfully associated to AP 105-a and data transfer can begin.

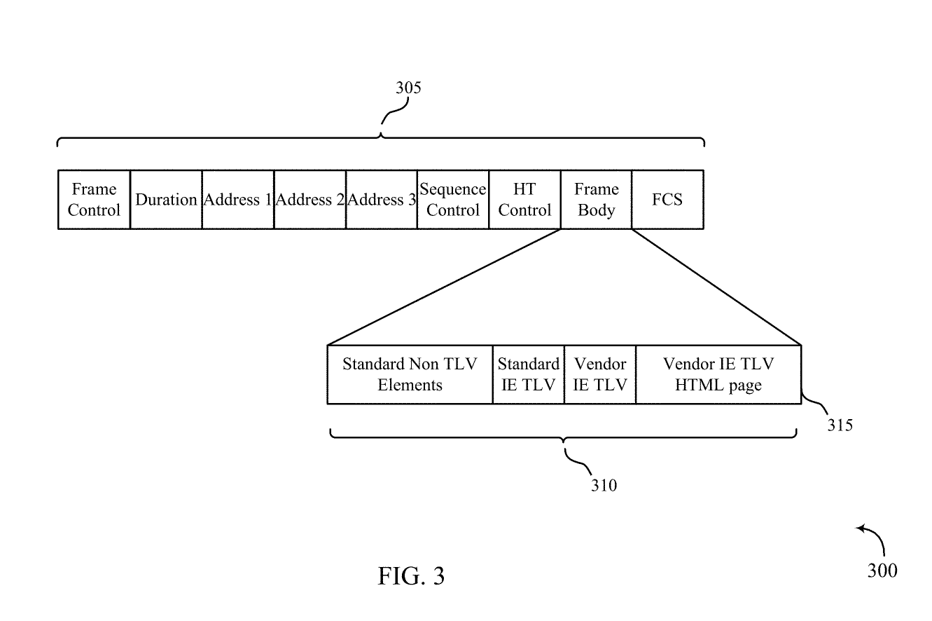

FIG. 3 illustrates an example of a probe response diagram 300 in accordance with aspects of the present disclosure. In some cases, probe response diagram 300 may represent aspects of techniques performed by AP 105 as described with reference to FIGS. 1 and 2.

Probe response frame 305 may be transmitted by an AP 105 to a STA 115 when one or more parameters between the devices are compatible. A MAC header of probe response frame 305 is the source address for the frame. When frames are relayed through the AP 105, the AP 105 uses its wireless interface as the transmitter address. The AP's interface address is also the basic service set identifier (BSSID).

Frame subset 310 depicts an expanded view of portions of data that may be contained with the frame body of probe response frame 305. Frame subset 310 includes different IEs that are specified in the 802.11 specification. This includes both standard and vendor specific Type-length-value (TLV) based IEs. The TLVs may be optional information inside a protocol. The type and length are fixed in size while the value field is of variable size. The type field is a binary code, often simply alphanumeric, which indicates the kind of field that this part of the message represents. The length is the size of the value field. The value field is a variable-sized series of bytes which contains data for this part of the message.

Frame 315 may represent a vendor IE TLV that comprises an HTML page with pictorial content. The pictorial content may be a brand icon or a picture of a face. The pictorial content may also be a graphics interchange format (GIF) image or any other suitable image format. The vendor IE TLV may also include an indication of a data size of the pictorial content.

Frame subset 310 may be represented as the following:

beacon_frame: {list of standard data Non-TLVs} {standard IEs TLVs}{Vendor IE TLVs} { Vendor IE TLV: VENDOR_HTML, Length: N, HTML_CONTENT of N bytes}

Where HTML_CONTENT can be any HTML page with pictorial content within it.

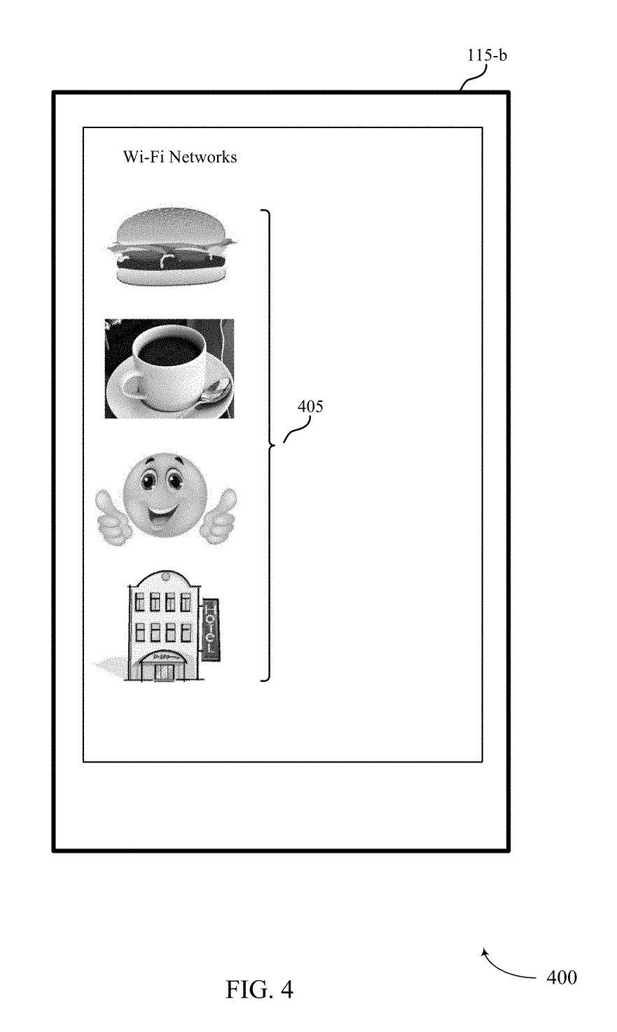

FIG. 4 illustrates an example of a graphical depiction 400 by a wireless station of a rendering of pictorial content within an arrangement of the available wireless access points for selection in accordance with aspects of the present disclosure. In some cases, graphical depiction 400 may represent aspects of techniques performed by STA 115 as described with reference to FIGS. 1-3.

FIG. 4 shows a STA 115-b that is displaying an arrangement of the available wireless APs 405 for selection. In this embodiment, STA 115-b has received a probe response frame from at least the available APs 405 in response to a transmitted probe request frame. The APs may have identified at least one compatible parameter with STA 115-b. From the probe response frames from available APs 405, STA 115-b may have retrieved associated pictorial content from the APs respective probe response frames. The pictorial content may be a brand icon or a picture of a face and may be in a GIF image format. For example, the icons displayed by STA 115-b may be various public establishments such as a restaurant, coffee shop, hotel, etc. The icon displayed by STA 115-b may also be private networks operated by either known or unknown individuals.

FIG. 5 shows a block diagram 500 of a wireless device 505, and in one embodiment, components, for example as shown in FIGS. 5-7 each include a circuit or circuitry for supporting enhanced network selection mechanisms through embedded HTML pages in accordance with various aspects of the present disclosure. Wireless device 505 may be an example of aspects of a access point (AP) 105 as described with reference to FIG. 1. Wireless device 505 may include receiver 510, AP Probe Frame Evaluator 515, and transmitter 520. Wireless device 505 may also include a processor. Each of these components may be in communication with one another (e.g., via one or more buses).

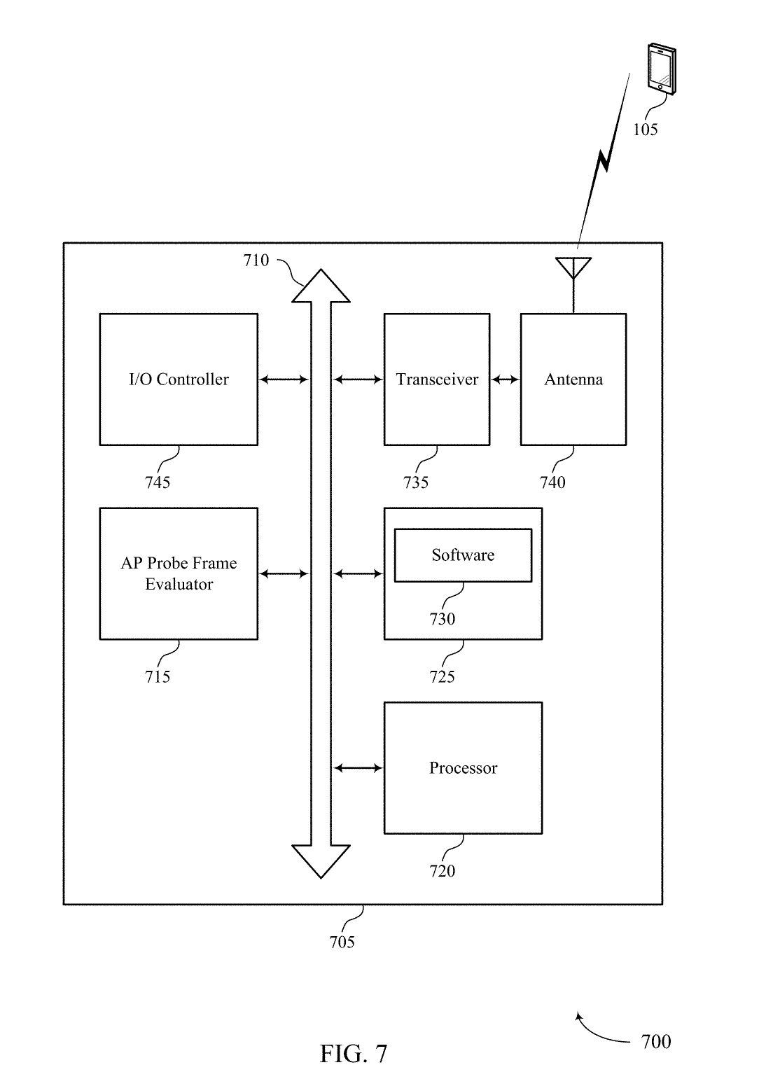

Receiver 510 may receive information such as packets, user data, or control information associated with various information channels (e.g., control channels, data channels, and information related to enhanced network selection mechanisms through embedded HTML pages, etc.). Information may be passed on to other components of the device. The receiver 510 may be an example of aspects of the transceiver 735 described with reference to FIG. 7. Receiver 510 may receive a probe request frame that is utilized in part by a wireless station to determine available wireless access points within a proximity of the wireless station.

AP Probe Frame Evaluator 515 may be an example of aspects of the AP Probe Frame Evaluator 715 described with reference to FIG. 7. AP Probe Frame Evaluator 515 may identify at least one compatible parameter with the wireless station based on the received probe request frame. AP Probe Frame Evaluator 515 may receive messages 525 from receiver 510, such as probe request frames from one or more STAs 115.

AP Probe Frame Evaluator 515 may also pass messages to transmitter 520 which may include a message 530 comprising a probe response frame which may include a vendor information element (IE) type-length-value (TLV) that comprises a hypertext markup language (HTML) page with pictorial content. The probe response frame may be transmitted at a supported data rate for an associated STA 115. AP Probe Frame Evaluator 515 may also pass a message 530 associated with the pictorial content to transmitter 520 which may comprise of a website of a vendor associated with the pictorial content, a sales offer from the vendor, and/or a message from an operator of the wireless access point.

Transmitter 520 may transmit signals generated by other components of the device. In some examples, the transmitter 520 may be collocated with a receiver 510 in a transceiver module. In some examples, transmitter 520 may transmit a message 530 received from AP Probe Frame Evaluator 515. For example, the transmitter 520 may be an example of aspects of the transceiver 735 described with reference to FIG. 7. The transmitter 520 may include a single antenna, or it may include a set of antennas.

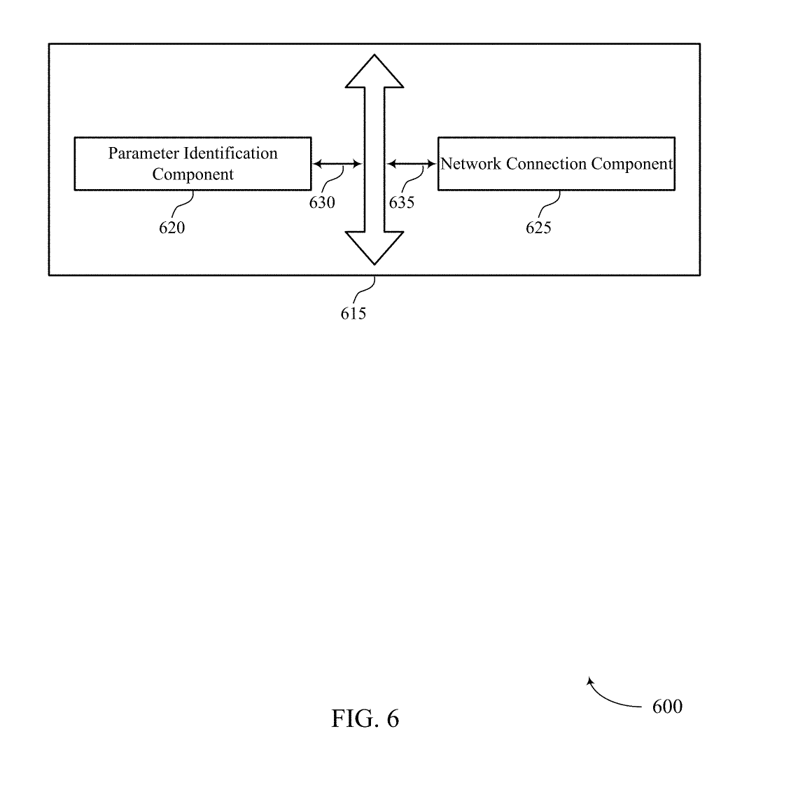

FIG. 6 shows a block diagram 600 of a AP Probe Frame Evaluator 615 that supports enhanced network selection mechanisms through embedded HTML pages in accordance with various aspects of the present disclosure. The AP Probe Frame Evaluator 615 may be an example of aspects of a AP Probe Frame Evaluator 515 or a AP Probe Frame Evaluator 715 described with reference to FIGS. 5 and 7. The AP Probe Frame Evaluator 615 may include parameter identification component 620 and network connection component 625. Each of these modules may communicate, directly or indirectly, with one another (e.g., via one or more buses).

Parameter identification component 620 may identify at least one compatible parameter with the wireless station based on the received probe request frame. The parameter identification component 620 may receive the parameter from message 630 via a bus. The compatible parameter may be a supported data rate. Network connection component 625 may associate an AP 105 with a wireless station 105 over a network connection. Network connection component 625 may communicate network protocols, messages, etc., through message 635 via a bus.

FIG. 7 shows a diagram of a system 700 including a device 705 that supports enhanced network selection mechanisms through embedded HTML pages in accordance with various aspects of the present disclosure. Device 705 may be an example of or include the components of wireless device 505, wireless device 605, or a AP 105 as described above, e.g., with reference to FIGS. 1, 5, and 6. Device 705 may include components for bi-directional voice and data communications including components for transmitting and receiving communications, including AP Probe Frame Evaluator 715, processor 720, memory 725, software 730, transceiver 735, antenna 740, and I/O controller 745. These components may be in electronic communication via one or more busses (e.g., bus 710).

Processor 720 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 720 may be configured to operate a memory array using a memory controller. In other cases, a memory controller may be integrated into processor 720. Processor 720 may be configured to execute computer-readable instructions stored in a memory to perform various functions (e.g., functions or tasks supporting enhanced network selection mechanisms through embedded HTML pages).

Memory 725 may include random access memory (RAM) and read only memory (ROM). The memory 725 may store computer-readable, computer-executable software 730 including instructions that, when executed, cause the processor to perform various functions described herein. In some cases, the memory 725 may contain, among other things, a basic input/output system (BIOS) which may control basic hardware and/or software operation such as the interaction with peripheral components or devices.

Software 730 may include code to implement aspects of the present disclosure, including code to support enhanced network selection mechanisms through embedded HTML pages. Software 730 may be stored in a non-transitory computer-readable medium such as system memory or other memory. In some cases, the software 730 may not be directly executable by the processor but may cause a computer (e.g., when compiled and executed) to perform functions described herein.

Transceiver 735 may communicate bi-directionally, via one or more antennas, wired, or wireless links as described above. For example, the transceiver 735 may represent a wireless transceiver and may communicate bi-directionally with another wireless transceiver. The transceiver 735 may also include a modem to modulate the packets and provide the modulated packets to the antennas for transmission, and to demodulate packets received from the antennas.

In some cases, the wireless device may include a single antenna 740. However, in some cases the device may have more than one antenna 740, which may be capable of concurrently transmitting or receiving multiple wireless transmissions.

I/O controller 745 may manage input and output signals for device 705. I/O controller 745 may also manage peripherals not integrated into device 705. In some cases, I/O controller 745 may represent a physical connection or port to an external peripheral. In some cases, I/O controller 745 may utilize an operating system such as iOS®, ANDROID®, MS-DOS®, MS-WINDOWS®, OS/2®, UNIX®, LINUX®, or another known operating system.

FIG. 8 shows a block diagram 800 of a wireless device 805, and in one embodiment, components, for example as shown in FIGS. 8-10 each include a circuit or circuitry for supporting enhanced network selection mechanisms through embedded HTML pages in accordance with various aspects of the present disclosure. Wireless device 805 may be an example of aspects of a station (STA) 115 as described with reference to FIG. 1. Wireless device 805 may include receiver 810, STA Probe Frame Evaluator 815, and transmitter 820. Wireless device 805 may also include a processor. Each of these components may be in communication with one another (e.g., via one or more buses).

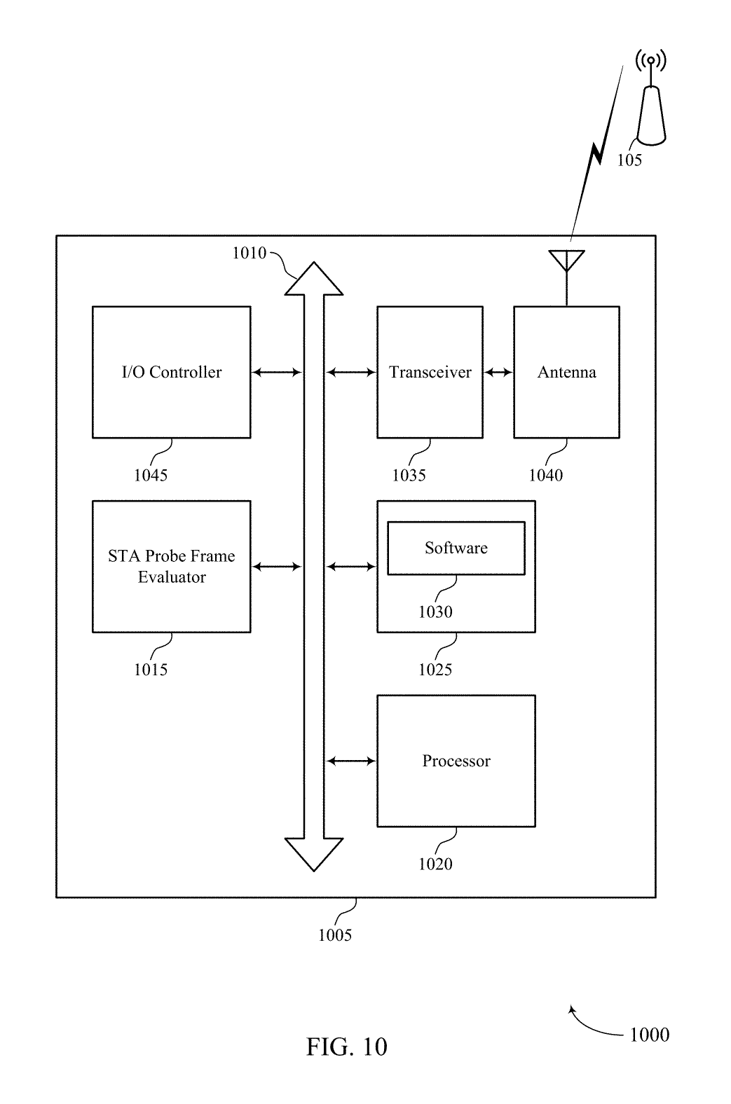

Receiver 810 may receive information such as packets, user data, or control information associated with various information channels (e.g., control channels, data channels, and information related to enhanced network selection mechanisms through embedded HTML pages, etc.). Information may be passed on to other components of the device. The receiver 810 may be an example of aspects of the transceiver 1035 described with reference to FIG. 10.

Receiver 810 may receive a probe response frame including a vendor information element (IE) type-length-value (TLV) that includes a hypertext markup language (HTML) page with pictorial content and receive information associated with the pictorial content over the network connection. The information may comprise of a website of a vendor associated with the pictorial content, a sales offer from the vendor, and/or a message from an operator of the wireless access point.

STA Probe Frame Evaluator 815 may be an example of aspects of the STA Probe Frame Evaluator 1015 described with reference to FIG. 10. STA Probe Frame Evaluator 815 may receive a message 825 from receiver 810. Message 825 may comprise a vendor information element (IE) type-length-value (TLV) that comprises a hypertext markup language (HTML) page with pictorial content. STA Probe Frame Evaluator 815 may also pass a message 830 to transmitter 820 which may indicate a selection of a wireless access point associated with the pictorial content.

Transmitter 820 may transmit signals generated by other components of the device. In some examples, the transmitter 820 may be collocated with a receiver 810 in a transceiver module. For example, the transmitter 820 may be an example of aspects of the transceiver 1035 described with reference to FIG. 10. The transmitter 820 may include a single antenna, or it may include a set of antennas. Transmitter 820 may transmit, by a wireless station, a probe request frame that is utilized in part by the wireless station to determine available wireless access points within a proximity of the wireless station.

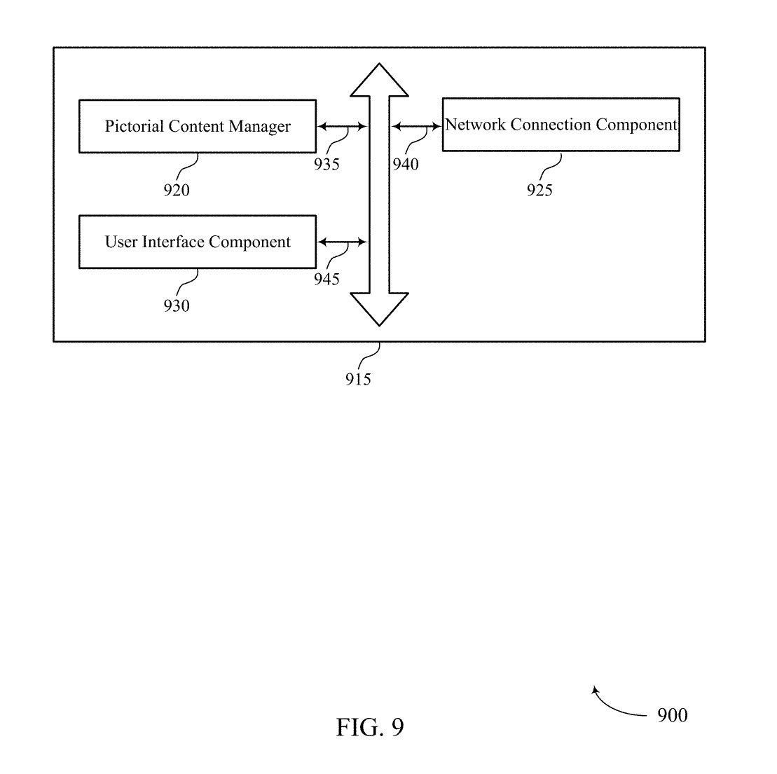

FIG. 9 shows a block diagram 900 of a STA Probe Frame Evaluator 915 that supports enhanced network selection mechanisms through embedded HTML pages in accordance with various aspects of the present disclosure. The STA Probe Frame Evaluator 915 may be an example of aspects of a STA Probe Frame Evaluator 1015 described with reference to FIGS. 8 and 10. The STA Probe Frame Evaluator 915 may include pictorial content manager 920, network connection component 935, and user interface component 930. Each of these modules may communicate, directly or indirectly, with one another (e.g., via one or more buses).

Pictorial content manager 920 may retrieve the pictorial content from the HTML page via message 935 and render the pictorial content within an arrangement of the available wireless access points for selection. Network connection component 925 may associate a wireless station 115 with a selected wireless access point 105 over a network connection. Network connection component 925 may communicate network protocols, messages, etc., through message 940 via a bus. User interface component 930 may receive a selection of a wireless access point associated with the pictorial content via message 945.

FIG. 10 shows a diagram of a system 1000 including a device 1005 that supports enhanced network selection mechanisms through embedded HTML pages in accordance with various aspects of the present disclosure. Device 1005 may be an example of or include the components of STA 115 as described above, e.g., with reference to FIG. 1. Device 1005 may include components for bi-directional voice and data communications including components for transmitting and receiving communications, including STA Probe Frame Evaluator 1015, processor 1020, memory 1025, software 1030, transceiver 1035, antenna 1040, and I/O controller 1045. These components may be in electronic communication via one or more busses (e.g., bus 1010).

Processor 1020 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1020 may be configured to operate a memory array using a memory controller. In other cases, a memory controller may be integrated into processor 1020. Processor 1020 may be configured to execute computer-readable instructions stored in a memory to perform various functions (e.g., functions or tasks supporting enhanced network selection mechanisms through embedded HTML pages).

Memory 1025 may include RAM and ROM. The memory 1025 may store computer-readable, computer-executable software 1030 including instructions that, when executed, cause the processor to perform various functions described herein. In some cases, the memory 1025 may contain, among other things, a BIOS which may control basic hardware and/or software operation such as the interaction with peripheral components or devices.

Software 1030 may include code to implement aspects of the present disclosure, including code to support enhanced network selection mechanisms through embedded HTML pages. Software 1030 may be stored in a non-transitory computer-readable medium such as system memory or other memory. In some cases, the software 1030 may not be directly executable by the processor but may cause a computer (e.g., when compiled and executed) to perform functions described herein.

Transceiver 1035 may communicate bi-directionally, via one or more antennas, wired, or wireless links as described above. For example, the transceiver 1035 may represent a wireless transceiver and may communicate bi-directionally with another wireless transceiver. The transceiver 1035 may also include a modem to modulate the packets and provide the modulated packets to the antennas for transmission, and to demodulate packets received from the antennas.

In some cases, the wireless device may include a single antenna 1040. However, in some cases the device may have more than one antenna 1040, which may be capable of concurrently transmitting or receiving multiple wireless transmissions.

I/O controller 1045 may manage input and output signals for device 1005. I/O controller 1045 may also manage peripherals not integrated into device 1005. In some cases, I/O controller 1045 may represent a physical connection or port to an external peripheral. In some cases, I/O controller 1045 may utilize an operating system such as iOS®, ANDROID®, MS-DOS®, MS-WINDOWS®, OS/2®, UNIX®, LINUX®, or another known operating system.

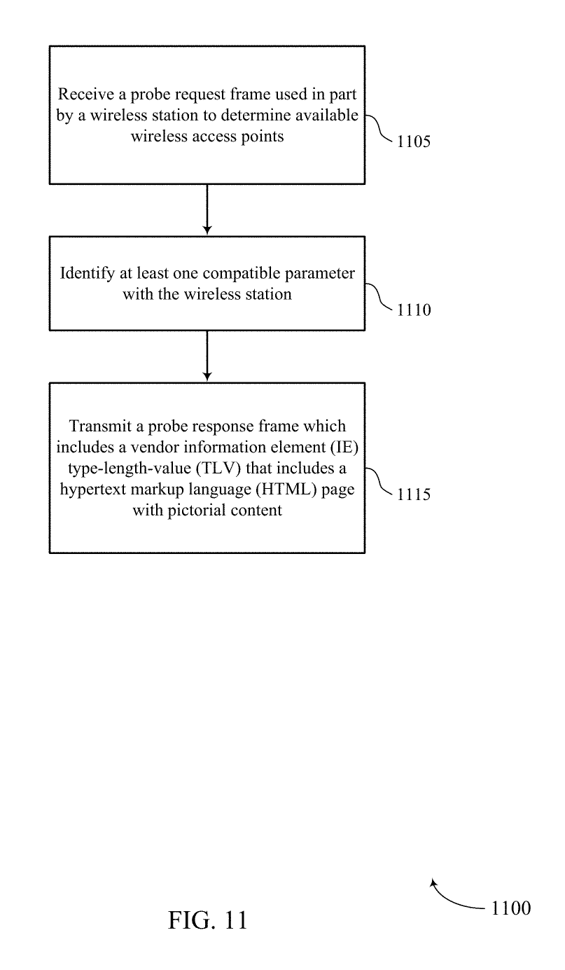

FIG. 11 shows a flowchart illustrating a method 1100 for enhanced network selection mechanisms through embedded HTML pages in accordance with various aspects of the present disclosure. The operations of method 1100 may be implemented by a AP 105 or its components as described herein. For example, the operations of method 1100 may be performed by a AP Probe Frame Evaluator as described with reference to FIGS. 5 through 7. In some examples, a AP 105 may execute a set of codes to control the functional elements of the device to perform the functions described below. Additionally or alternatively, the AP 105 may perform aspects the functions described below using special-purpose hardware.

At block 1105 the AP 105 may receive a probe request frame that is utilized in part by a wireless station to determine available wireless access points within a proximity of the wireless station. The operations of block 1105 may be performed according to the methods described with reference to FIGS. 1 through 4. In certain examples, aspects of the operations of block 1105 may be performed by a receiver as described with reference to FIGS. 5 through 7.

At block 1110 the AP 105 may identify at least one compatible parameter with the wireless station based at least in part on the received probe request frame. The compatible parameter may be a supported data rate. The operations of block 1110 may be performed according to the methods described with reference to FIGS. 1 through 4. In certain examples, aspects of the operations of block 1110 may be performed by a parameter identification component as described with reference to FIGS. 5 through 7.

At block 1115 the AP 105 may transmit a probe response frame in response to the probe request frame, the probe response frame comprising a vendor information element (IE) type-length-value (TLV) that comprises a hypertext markup language (HTML) page with pictorial content. The probe response frame may be transmitted at the supported data rate. The operations of block 1115 may be performed according to the methods described with reference to FIGS. 1 through 4. In certain examples, aspects of the operations of block 1115 may be performed by a transmitter as described with reference to FIGS. 5 through 7.

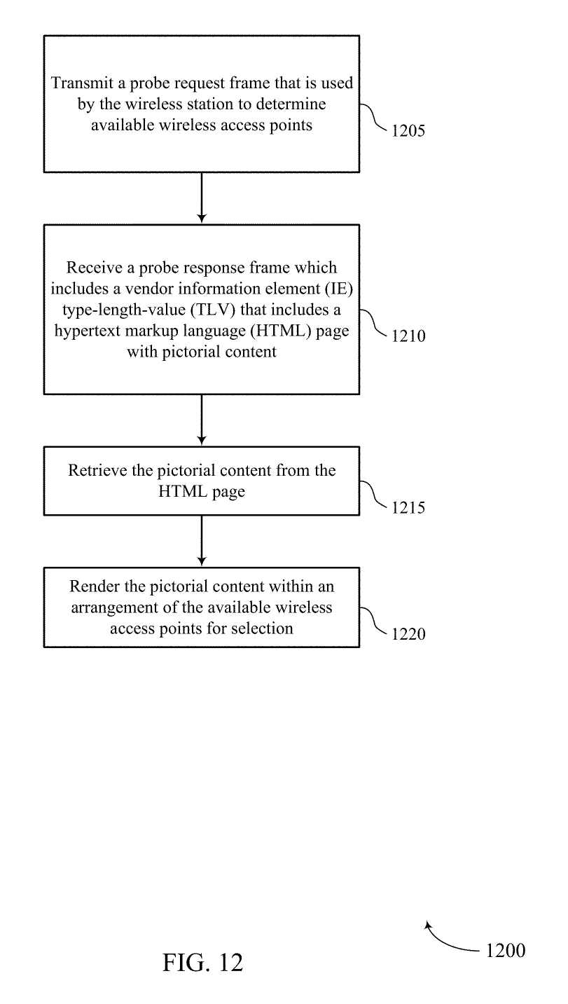

FIG. 12 shows a flowchart illustrating a method 1200 for enhanced network selection mechanisms through embedded HTML pages in accordance with various aspects of the present disclosure. The operations of method 1200 may be implemented by a STA 115 or its components as described herein. For example, the operations of method 1200 may be performed by a STA Probe Frame Evaluator as described with reference to FIGS. 8 through 10. In some examples, a STA 115 may execute a set of codes to control the functional elements of the device to perform the functions described below. Additionally or alternatively, the STA 115 may perform aspects the functions described below using special-purpose hardware.

At block 1205 the STA 115 may transmit a probe request frame that is utilized in part by the wireless station to determine available wireless access points within a proximity of the wireless station. The operations of block 1205 may be performed according to the methods described with reference to FIGS. 1 through 4. In certain examples, aspects of the operations of block 1205 may be performed by a transmitter as described with reference to FIGS. 8 through 10.

At block 1210 the STA 115 may receive a probe response frame in response to the probe request frame, the probe response frame comprising a vendor information element (IE) type-length-value (TLV) that comprises a hypertext markup language (HTML) page with pictorial content. The operations of block 1210 may be performed according to the methods described with reference to FIGS. 1 through 4. In certain examples, aspects of the operations of block 1210 may be performed by a receiver as described with reference to FIGS. 8 through 10.

At block 1215 the STA 115 may retrieve the pictorial content from the HTML page. The operations of block 1215 may be performed according to the methods described with reference to FIGS. 1 through 4. In certain examples, aspects of the operations of block 1215 may be performed by a pictorial content manager as described with reference to FIGS. 8 through 10.

At block 1220 the STA 115 may render the pictorial content within an arrangement of the available wireless access points for selection. The STA 115 may also receive a selection of a wireless access point associated with the pictorial content. The operations of block 1220 may be performed according to the methods described with reference to FIGS. 1 through 4. In certain examples, aspects of the operations of block 1220 may be performed by a pictorial content manager as described with reference to FIGS. 8 through 10.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. An apparatus for wireless communication, in a system comprising:
a processor;
memory in electronic communication with the processor; and
instructions stored in the memory and operable, when executed by the processor, to cause the apparatus to:
receive, at a wireless access point, a probe request frame that is utilized in part by a wireless station to determine available wireless access points within a proximity of the wireless station;
identify at least one compatible parameter with the wireless station based at least in part on the received probe request frame; and
transmit a probe response frame in response to the probe request frame, the probe response frame comprising a vendor information element (IE) type-length-value (TLV) that comprises a value field comprising information for retrieving a hypertext markup language (HTML) page with pictorial content, wherein at least one of the value field or a type field of the vendor IE TLV comprises an indication of a data size of the pictorial content.

2. The apparatus of claim 1, wherein the pictorial content is a brand icon or a picture of a face.

3. (canceled)

4. The apparatus of claim 1, wherein the pictorial content is a graphics interchange format (GIF) image.

5. The apparatus of claim 1, wherein the instructions are further executable by the processor to:
associate with the wireless station over a network connection; and transmit information associated with the pictorial content over the network connection.

6. The apparatus of claim 5, wherein the transmitted information comprises a website of a vendor associated with the pictorial content, a sales offer from the vendor, and/or a message from an operator of the wireless access point.

7. The apparatus of claim 1, wherein the at least one compatible parameter is a supported data rate.

8. The apparatus of claim 7, wherein the probe response frame is transmitted at the supported data rate.

9. An apparatus for wireless communication, in a system comprising:
a processor;
memory in electronic communication with the processor; and
instructions stored in the memory and operable, when executed by the processor, to cause the apparatus to:
transmit, by a wireless station, a probe request frame that is utilized in part by the wireless station to determine available wireless access points within a proximity of the wireless station;
receive a probe response frame in response to the probe request frame, the probe response frame comprising a vendor information element (IE) type-length-value (TLV) that comprises a value field comprising information for retrieving a hypertext markup language (HTML) page with pictorial content, wherein at least one of the value field or a type field of the vendor IE TLV comprises an indication of a data size of the pictorial content;
retrieve the pictorial content from the HTML page; and
render the pictorial content within an arrangement of the available wireless access points for selection.

10. The apparatus of claim 9, wherein the pictorial content is a brand icon or a picture of a face.

11. (canceled)

12. The apparatus of claim 9, wherein the pictorial content is a graphics interchange format (GIF).

13. The apparatus of claim 9, wherein the instructions are further executable by the processor to:
receive a selection of a wireless access point associated with the pictorial content;
associate with the selected wireless access point over a network connection; and
receive information associated with the pictorial content over the network connection.

14. The apparatus of claim 13, wherein the received information comprises a website of a vendor associated with the pictorial content, a sales offer from the vendor, and/or a message from an operator of the selected wireless access point.

15. A method for wireless communication, comprising:
receiving, at a wireless access point, a probe request frame that is utilized in part by a wireless station to determine available wireless access points within a proximity of the wireless station;
identifying at least one compatible parameter with the wireless station based at least in part on the received probe request frame; and
transmitting a probe response frame in response to the probe request frame, the probe response frame comprising a vendor information element (IE) type-length-value (TLV) that comprises a value field comprising information for retrieving a hypertext markup language (HTML) page with pictorial content, wherein at least one of the value field or a type field of the vendor IE TLV comprises an indication of a data size of the pictorial content.

16. The method of claim 15, wherein the pictorial content is a brand icon or a picture of a face.

17. (canceled)

18. The method of claim 15, wherein the pictorial content is a graphics interchange format (GIF) image.

19. The method of claim 15, further comprising:
associating with the wireless station over a network connection; and
transmitting information associated with the pictorial content over the network connection.

20. The method of claim 19, wherein the transmitted information comprises a website of a vendor associated with the pictorial content, a sales offer from the vendor, and/or a message from an operator of the wireless access point.
